(19) United States
(12) Patent Application Publication
(10) Pub. No.: US 2026/0366941 A1
(43) Pub. Date: Nov. 19, 2026

(54) IMPACT DETECTION SYSTEM FOR COMPOSITE OVERWRAPPED PRESSURE VESSELS

(71) Applicant: VOLVO TRUCK CORPORATION, Göteborg (SE)

(72) Inventors: Sondre LANDVIK, Göteborg (SE); Ringolds JARGANS, Trollhättan (SE)

(73) Assignee: VOLVO TRUCK CORPORATION, Göteborg (SE)

(21) Appl. No.: 19/158,720

(22) PCT Filed: Feb. 23, 2023
(86) PCT No.: PCT/IB2023/051693

§ 371 Date: Aug. 21, 2025

(51) Int. Cl. G01L 23/26; F17C 13/02; F17C 13/12

(52) U.S. Cl. CPC G01L 23/26; F17C 13/025; F17C 13/12; F17C 2201/0109; F17C 2205/0107; F17C 2221/012; F17C 2221/033; F17C 2250/036; F17C 2250/0434; F17C 2260/04; F17C 2270/0168

(57) ABSTRACT

A system for impact detection, comprising a pressure vessel configured to store a fuel, said pressure vessel comprising a wall having an outer surface and an inner surface defining a cavity therein for storing said fuel. The system further comprises a pressure sensor assembly positioned to be in contact with a portion of said outer surface of said wall. The pressure sensor assembly comprises a flexible layer adapted to conform to said portion of said outer surface of said wall, a tube within said flexible layer, a pressure sensor positioned to detect a change in pressure within said tube during an impact upon said flexible layer, and a processor in communication with said pressure sensor, said processor configured to detect the impact based on the change in pressure.

### TECHNICAL FIELD

The disclosure relates generally to fuel tank systems. In particular aspects, the disclosure relates to tanks for gaseous fuels and cryogenically liquified gaseous fuels. The disclosure can be applied in heavy-duty vehicles, such as trucks, buses, and construction equipment, among other vehicle types. Although the disclosure may be described with respect to a particular vehicle, the disclosure is not restricted to any particular vehicle.

### BACKGROUND

Fuel tank systems for vehicles include single-walled, composite overwrapped pressure vessels (CPOV) for storing gaseous fuels such as H2 (hydrogen) and CNG (compressed natural gas), and double-walled vessels for storing cryogenically liquified gases such as LNG (liquified natural gas) and LH2 (liquified hydrogen). These fuel tanks may be mounted to any type of vehicle, including but not limited to trucks, boats, trains, airplanes.

Using the wheelbase volume to install the tanks allows larger diameters, and significant higher energy densities packed on the vehicle. However, use of larger tanks involves a lot of structural material, which reduces the volume of stored fuel, and thus driving range. Using smaller tanks instead involves large heavy protective frames, and an increased number of valves and leakage points.

On a commercial truck, tanks may be located in the wheelbase area, mounted outside the frame rails or suspended on the outside of the chassis of the vehicle. These tanks therefore risk experiencing damage from the outside, especially from below (driving on a rocky surface, ferry ramp etc.). Such damage may be difficult to detect. In a large vehicle (e.g., a 40-ton truck), the driver may not notice such an impact and continue driving, potentially exacerbating the damage.

The consequences of such damage may be severe due to extreme pressures, and the presence of flammable or explosive gases and liquids. Inspection of the tanks is difficult and time consuming, and may involve lifting the vehicle or inspection above a pit. Components of the tank may also have to be removed to perform a full inspection.

Accordingly, an impact detection system for fuel tanks on vehicles that does not further increase the weight of the vehicle and reduce the payload is desirable.

### SUMMARY

According to a first aspect of the disclosure, a system for impact detection comprises a pressure vessel configured to store a fuel, said pressure vessel comprising a wall having an outer surface and an inner surface defining a cavity therein for storing said fuel. The system further comprises a pressure sensor assembly positioned to be in contact with a portion of said outer surface of said wall. The pressure sensor assembly comprises a flexible layer adapted to conform to said portion of said outer surface of said wall, a tube within said flexible layer, a pressure sensor positioned to detect a change in pressure within said tube during an impact upon said flexible layer, and a processor in communication with said pressure sensor, said processor configured to detect the impact based on the change in pressure. The first aspect of the disclosure may provide improved impact detection for pressure vessels. A technical benefit may include reduced weight for a vehicle configured with the system.

In some examples, including in at least one preferred example, optionally said tube is arranged in an alternating pattern extending back and forth along an axis of the pressure vessel. A technical benefit may include an increased surface area of the pressure vessel for detection of impact events.

In some examples, including in at least one preferred example, optionally said tube has a first end and a second end that are adjacent due to said alternating pattern, and said pressure sensor is arranged proximate to both the first end and the second end of said tube. A technical benefit may include improved detection of impact events.

In some examples, including in at least one preferred example, optionally said pressure sensor assembly further comprises a plurality of tubes arranged in parallel within said flexible layer, and a plurality of pressure sensors each being in communication with said processor and each being positioned to detect a change in pressure within at least one of said plurality of tubes during said impact. A technical benefit may include an increased surface area of the pressure vessel for detection of impact events.

In some examples, including in at least one preferred example, optionally said tube is a first tube and said pressure sensor is a first pressure sensor, and said pressure sensor assembly further comprises a second tube embedded within said flexible layer and a second pressure sensor, said second pressure sensor being in communication with said processor and being positioned to detect a change in pressure within said second tube during said impact. A technical benefit may include improved detection of impact events.

In some examples, including in at least one preferred example, optionally said pressure sensor is a first pressure sensor, said first pressure sensor being further positioned at a first end of the tube, and said pressure sensor assembly further comprises a second pressure sensor, said second pressure sensor being in communication with said processor and being positioned at a second end of the tube to detect a change in pressure within said tube during said impact. A technical benefit may include improved detection of impact events, as well as detecting a location or position of the impact.

In some examples, including in at least one preferred example, optionally said outer surface of said pressure vessel comprises an overwrapped layer of composite material, and said flexible layer is positioned to be in contact with said overwrapped layer of composite material. A technical benefit may include improved detection of impact events.

In some examples, including in at least one preferred example, optionally at least a portion of said tube is in direct contact with or partially embedded within said outer surface of said wall. A technical benefit may include improved detection of impact events.

In some examples, including in at least one preferred example, optionally said tube is fully embedded within said flexible layer. A technical benefit may include improved detection of impact events.

In some examples, including in at least one preferred example, optionally said flexible layer is composed of a material that propagates a force from said impact to said tube. A technical benefit may include improved detection of impact events.

In some examples, including in at least one preferred example, optionally said processor is further configured to determine at least one of a position of said impact and a severity of said impact. A technical benefit may include improved detection of impact events.

According to a second aspect of the disclosure, a vehicle comprises a frame and a pressure vessel mounted to said frame, said pressure vessel being configured to store a fuel and comprising a wall having an outer surface and an inner surface defining a cavity therein for storing said fuel. The vehicle further comprises a pressure sensor assembly positioned to be in contact with a portion of said outer surface of said wall. The pressure sensor assembly comprises a flexible layer adapted to conform to said portion of said outer surface of said wall, a tube within said flexible layer, a pressure sensor positioned to detect a change in pressure within said tube during an impact upon said flexible layer, and a processor in communication with said pressure sensor, said processor configured to detect the impact based on the change in pressure. The second aspect of the disclosure may provide improved impact detection for pressure vessels. A technical benefit may include reduced weight for the vehicle.

In some examples, including in at least one preferred example, optionally said tube is arranged in an alternating pattern extending back and forth along an axis of the pressure vessel. A technical benefit may include an increased surface area of the pressure vessel for detection of impact events.

In some examples, including in at least one preferred example, optionally said tube has a first end and a second end that are adjacent due to said alternating pattern, and said pressure sensor is arranged proximate to both the first end and the second end of said tube. A technical benefit may include improved detection of impact events.

In some examples, including in at least one preferred example, optionally said pressure sensor assembly further comprises a plurality of tubes arranged in parallel within said flexible layer, and a plurality of pressure sensors each being in communication with said processor and each being positioned to detect a change in pressure within at least one of said plurality of tubes during said impact. A technical benefit may include an increased surface area of the pressure vessel for detection of impact events.

In some examples, including in at least one preferred example, optionally said pressure sensor is a first pressure sensor, said first pressure sensor being further positioned at a first end of the tube, and said pressure sensor assembly further comprises a second pressure sensor, said second pressure sensor being in communication with said processor and being positioned at a second end of the tube to detect a change in pressure within said tube during said impact. A technical benefit may include improved detection of impact events.

In some examples, including in at least one preferred example, optionally said outer surface of said pressure vessel comprises an overwrapped layer of composite material, and said flexible layer is positioned to be in contact with said overwrapped layer of composite material. A technical benefit may include improved detection of impact events.

According to a third aspect of the disclosure, a sensor assembly for impact detection comprises a flexible layer, a tube within said flexible layer, a pressure sensor positioned to detect a change in pressure within said tube during an impact upon said flexible layer, and a processor in communication with said pressure sensor, said processor configured to detect the impact based on the change in pressure. The sensor assembly is positioned to be in contact with a portion of an outer surface of a wall of a pressure vessel configured to store a fuel. The third aspect of the disclosure may provide improved impact detection for pressure vessels. A technical benefit may include reduced weight for a vehicle configured with the sensor assembly.

In some examples, including in at least one preferred example, optionally said tube is arranged in an alternating pattern extending back and forth along an axis of the pressure vessel, and said tube has a first end and a second end that are adjacent due to said alternating pattern, and said pressure sensor is arranged proximate to both the first end and the second end of said tube. A technical benefit may include an increased surface area of the pressure vessel for detection of impact events.

In some examples, including in at least one preferred example, optionally said sensor assembly further comprises a plurality of tubes arranged in parallel within said flexible layer, and a plurality of pressure sensors each being in communication with said processor and each being positioned to detect a change in pressure within at least one of said plurality of tubes during said impact. A technical benefit may include an increased surface area of the pressure vessel for detection of impact events.

In some examples, including in at least one preferred example, optionally said pressure sensor is a first pressure sensor, said first pressure sensor being further positioned at a first end of the tube, and said sensor assembly further comprises a second pressure sensor, said second pressure sensor being in communication with said processor and being positioned at a second end of the tube to detect a change in pressure within said tube during said impact. A technical benefit may include improved detection of impact events.

In some examples, including in at least one preferred example, optionally said outer surface comprises an overwrapped layer of composite material, and said flexible layer is positioned to be in contact with said overwrapped layer of composite material. A technical benefit may include improved detection of impact events.

The disclosed aspects, examples (including any preferred examples), and/or accompanying claims may be suitably combined with each other as would be apparent to anyone of ordinary skill in the art.

Additional features and advantages are disclosed in the following description, claims, and drawings, and in part will be readily apparent therefrom to those skilled in the art or recognized by practicing the disclosure as described herein.

There are also disclosed herein computer systems, control units, code modules, computer-implemented methods, computer readable media, and computer program products associated with the above discussed technical benefits.

### BRIEF DESCRIPTION OF THE DRAWINGS

Examples are described in more detail below with reference to the appended drawings.

FIG. 1 shows an exemplary single-walled tank, according to an example.

FIG. 2A shows a burst CPOV tank after an impact, according to an example.

FIG. 2B schematically shows how an impact to the CPOV tank may cause a propagating delamination failure, according to an example.

FIG. 3 shows an exemplary double-walled tank, according to an example.

FIG. 4A shows an axial schematic view of an exemplary single-walled tank equipped with an impact detection system, according to an example.

FIG. 4B shows a radial schematic view of the single-walled tank in FIG. 4A.

FIG. 5 shows an axial schematic view of an exemplary single-walled tank equipped with an impact detection system, according to an example.

FIG. 6A shows an axial schematic view of an exemplary double-walled tank equipped with an impact detection system, according to an example.

FIG. 6B shows a radial schematic view of the double-walled tank in FIG. 6A.

FIG. 7 shows a schematic view of an exemplary tank equipped with a single-tube impact detection system, according to an example.

FIG. 8 shows a schematic view of an exemplary tank equipped with a single-tube impact detection system, according to an example.

FIG. 9 is a schematic diagram of an exemplary computer system for implementing examples disclosed herein, according to an example.

### DETAILED DESCRIPTION

The detailed description set forth below provides information and examples of the disclosed technology with sufficient detail to enable those skilled in the art to practice the disclosure.

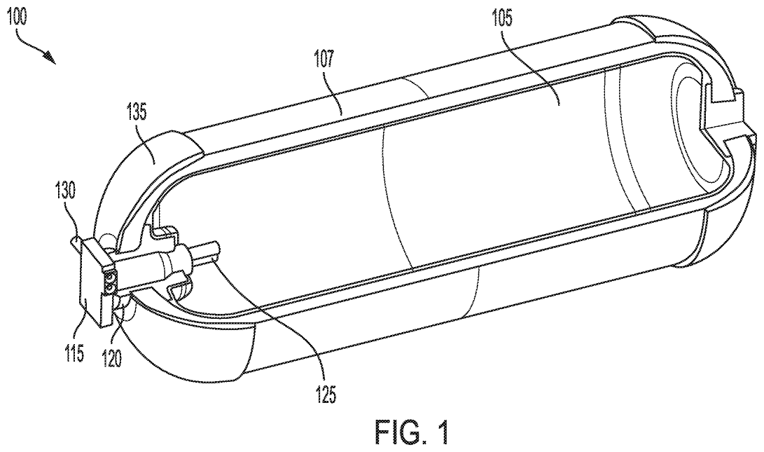

FIG. 1 shows an exemplary single-walled tank 100, according to some examples of the present disclosure. In this example, the tank 100 is a composite overwrapped pressure vessel (CPOV), that has a polymeric inner liner 105 completely overwrapped by a composite laminate 107. The tank 100 may be used to store gaseous fuels, including, but not limited to H2 (hydrogen) and CNG (compressed natural gas).

Additional components of the tank 100 may include a valve 115, a boss 120, a temperature sensor 125, and a thermally-activated pressure relief device (TPRD) 130. In addition, a dome 135 may provide additional protection to the exterior of the tank 100.

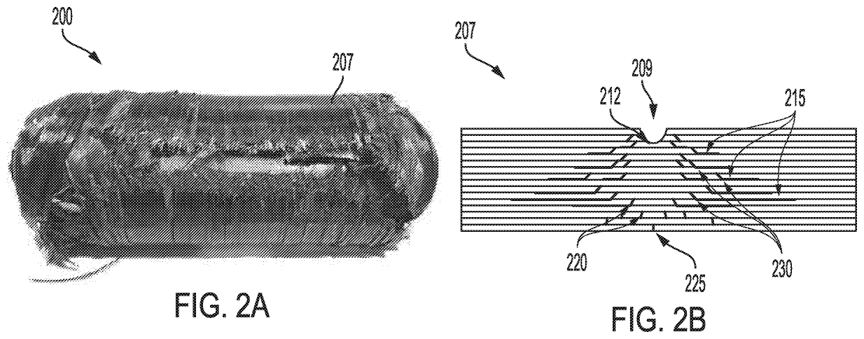

FIG. 2A shows an example of a burst CPOV tank 200 after an impact. In this example, the impact caused the CPOV tank 200 to burst open due to the pressure of the fuel gas inside, rupturing the overwrapped composite laminate 207.

FIG. 2B schematically shows how an impact to the CPOV tank 200 may cause a propagating delamination failure, within the composite laminate 207. At the impact location 209, there may be a visible surface deformation 212 at the surface of the composite laminate 207, for example. However, delamination 215 of the composite laminate 207 may also occur at deeper layers of the composite laminate 207. Additional hidden damage may occur at even deeper layers of the composite laminate 207, including matrix cracks 220 due to bending, fiber breakage 225, and matrix cracks 230 due to shear.

On a regular metallic tank (not shown), such an impact would deform the CPOV tank 200 and leave a dent that could be visible observed if inspected. As seen in FIG. 2B, however, damage to a composite vessel such as the CPOV tank 200 may not be visible at all on the surface, but still compromise the tank's structural integrity.

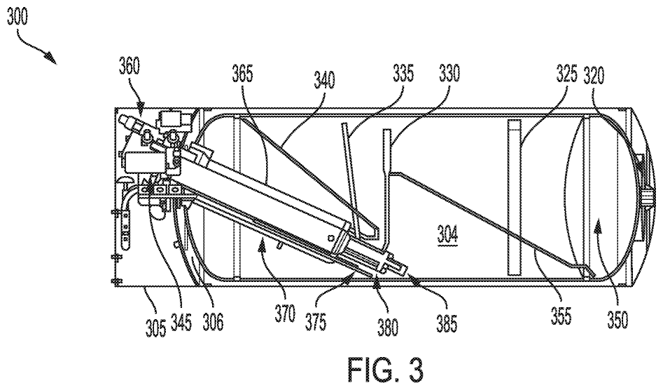

FIG. 3 shows an exemplary double-walled tank 300, according to some examples of the present disclosure. In this example, the tank 300 may be used to store cryogenically liquified gases including but not limited to LNG (liquified natural gas) and LH2 (liquified hydrogen). Since LNG is stored at typically −150 °C and LH2 at temperatures as low as −250 °C, proper insulation is achieved by the use of double tanks. The tank 300 includes an inner tank 304 that holds the liquid/gas combination at a low temperature, and outer tank 305 (also referred to as a shroud), and a gap 306 between the inner tank 304 and the outer tank 305. The gap 306 may be filled with insulating materials (not shown) or may be evacuated.

Additional components of the tank 300 may include a suspension mechanism 320 in the gap 306 between the inner tank 304 and the outer tank 305, a liquid level sensor 325, a fill line and venturi 330, a vent tube 335, a secondary relief tube 340, a high-pressure gas filter 345, an ullage space 350, an ullage drain tube 355, and a pump system 360. The pump system 360 may include a drive shaft outer housing 365, a vacuum jacket 370, a liquid drain tube 375, a pump cylinder 380, and a suction filter 385.

If the tank 300 undergoes an impact, the visible external damage to the outer tank 305 may be minor, in the form of a dent. However, even minimal damage to the outer tank 305 may still be significant enough to cause damage or deterioration to the inner tank 304, and one or more of the tank components 320-385. Failure in any of these critical subsystems would not necessarily be discernable from a visual inspection of the outer tank 305.

A number of examples of impact detection systems for fuel tanks are now described. These impact detection systems are desirable for single-walled tanks (e.g., the CPOV tank 200 described above with respect to FIG. 2) and double-walled tanks (e.g., the tank 300 described above with respect to FIG. 3), to provide live monitoring of impacts and warnings regarding potentially compromised structural integrity, even if there is no apparent visual damage. By providing live impact detection, integrated impact detection systems may prevent catastrophic failure by alerting a vehicle operator or mechanic of the potential for dangerous leaks of explosive and flammable liquids and gases.

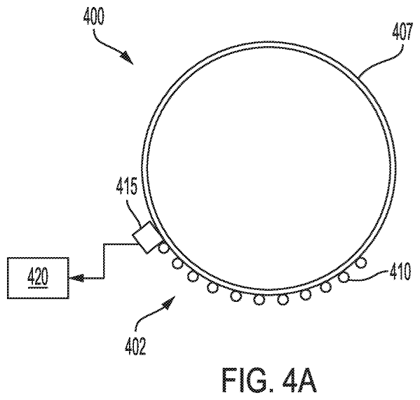

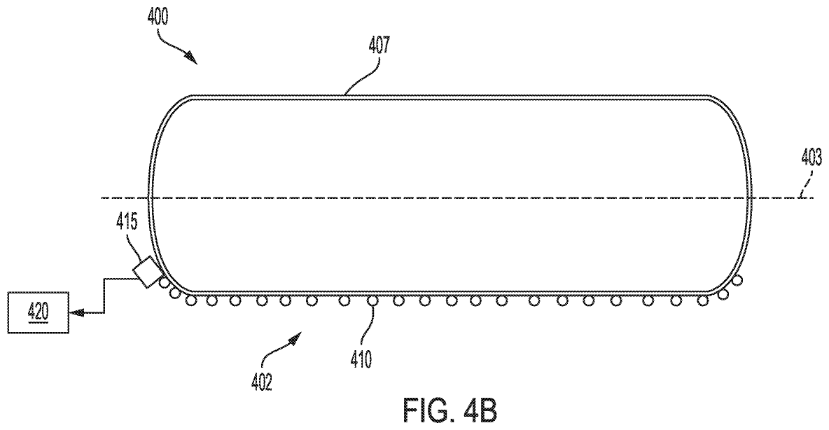

FIG. 4A and FIG. 4B show schematic views of an exemplary single-walled tank 400 equipped with an impact detection system 402, according to some examples of the present disclosure. The schematic view of the tank 400 in FIG. 4A is an axial view from the front of the tank 400 along the long axis of the tank 400 (not shown in FIG. 4A). The schematic view of the tank 400 in FIG. 4B is a radial view from the side of the tank perpendicular to the long axis 403 (indicated in FIG. 4B by a dashed line). The tank 400 is similar to previous examples, including but not limited to the example of the tank 100 discussed above with respect to FIG. 1, and like reference numerals have been used wherever possible to refer to the same or similar components. Any of the various features discussed with any one of the examples discussed herein may also apply to and be used with any other examples.

In this example, the tank 400 is a composite overwrapped pressure vessel (CPOV), that is completely overwrapped by a composite laminate 407. The tank 400 may be used to store gaseous fuels, including, but not limited to H2 (hydrogen) and CNG (compressed natural gas).

In the examples of FIG. 4A and FIG. 4B, the impact detection system 402 is positioned to be in contact with at least a portion of the outer surface of the tank 400. Since in this example the tank is a CPOV tank, the impact detection system 402 is placed directly in contact with the composite laminate 407.

In this example, the impact detection system 402 includes one or more flexible hollow tubes 410 that are adapted to conform to the outer surface of the tank 400. For example, the hollow tubes 410 may be made of flexible silicone, filled with air or another gas, or a liquid. The hollow tubes 410 are primarily placed alongside the underside of the tank 400, which is the region that is most susceptible to impacts. The hollow tubes 410 may be affixed directly using fasteners, adhesives, or other mechanisms that substantially conform the hollow tubes 410 to the surface of the tank 400. However, the positioning of the impact detection system 402 is not limited to the underside, and it may also be placed anywhere along the outside of the tank 400 where impacts could potentially occur, including but not limited to the sides of the tank 400 for side impact detection.

The impact detection system 402 also includes at least one pressure sensor 415 positioned to detect a change in pressure within the hollow tubes 410 during an impact upon the tank 400 in the vicinity of the impact detection system 402. For the sake of clarity, only a single pressure sensor 415 is shown in FIG. 4A and FIG. 4B, and the description below also applies to other pressure sensors of the impact detection system 402. Each of the hollow tubes 410 is associated with at least one such pressure sensor 415. For example, each end of a tube may be in communication with a corresponding pressure sensor. An impact event would compress at least a portion of the hollow tubes 410 proximate to the point of impact, causing a decrease in volume of the air inside the hollow tubes 410, and thereby increasing the pressure inside. The increase in pressure within an affected hollow tube 410 is then detected by a corresponding pressure sensor 415.

The pressure sensor 415 is in communicative contact with a processor 420. The pressure sensor 415 sends a signal to the processor 420 during detection of a change (e.g., a transient spike or a constant change) in pressure in the hollow tubes 410. The processor 420 processes the signal and determines whether the change in pressure was due to an impact event. For example, an impact event may be detected if the change in pressure in the hollow tubes 410 has a specific temporal profile (as measured in units of time), exceeds a pre-determined, calibrated threshold (as measured in units of pressure), or both (as measured in units of pressure, time, or pressure over time). Different thresholds may be used for a first indication of the severity of the impact.

For example, when a first threshold is exceeded, the processor 420 may determine that the tank should be inspected at the next scheduled maintenance. When a second threshold is exceeded, the processor 420 may determine the vehicle should be taken for inspection at the earliest opportunity. When the processor 420 determines that a third threshold is exceeded, the processor 420 may determine that the vehicle should be removed from service immediately. The processor 420 may generate messages or signals to convey this information. The specific thresholds will depend on the specific configuration, such as the type of tank, tubes, materials within the tubes, etc.

In aspects where multiple sensors 415 are provided, the location of the impact vs the surface of the tank may be determined based on the timing at which the signal arrives at various sensors. The location information may be presented to a mechanic and/or driver to reduce the time of inspection needed, as well as to improve inspection quality after impact detection.

Upon detection of an impact event, the processor 420 may provide one or more notifications, such as a notification that the tank 400 has been hit, or a notification that further inspection of the tank 400 is needed. The notifications may be provided to any appropriate personnel, including but not limited to the operator of the vehicle on which the tank 400 is mounted, or a service technician who will inspect the tank 400.

In FIG. 4A, the hollow tubes 410 are arranged in an axial pattern, parallel to the long axis of the tank 400. Alternatively, as shown in FIG. 4B, the hollow tubes 410 may be arranged in a radial pattern, perpendicular to the long axis of the tank 400. The radial pattern may extend wholly or partially around the circumference of the tank 400.

The arrangement of the hollow tubes 410 is not limited to these configurations, but may instead be arranged in any pattern and orientation that provides sufficient spacing between the hollow tubes 410, to ensure that at least one of the hollow tubes 510 is impinged during any impact on the tank 400. The pattern may be dependent on the size and length of the tank 400, as well as the placement of the tank 400 on a vehicle and the expected area of concern where impacts may occur.

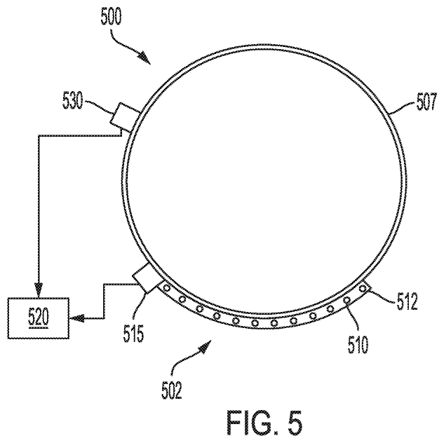

FIG. 5 shows an axial schematic view of an exemplary single-walled tank 500 equipped with an impact detection system 502, according to some examples of the present disclosure. The schematic view of the tank 500 in FIG. 5 is from the front of the tank 500 along the long axis of the tank 500 (not shown in FIG. 5). The tank 500 is similar to previous examples, including but not limited to the examples of the tank 100 and the tank 400, discussed above with respect to FIG. 1 and FIG. 4A, respectively, and like reference numerals have been used wherever possible to refer to the same or similar components. Any of the various features discussed with any one of the examples discussed herein may also apply to and be used with any other examples.

In this example, the tank 500 is a composite overwrapped pressure vessel (CPOV), that is completely overwrapped by a composite laminate 507. The tank 500 may be used to store gaseous fuels, including, but not limited to H2 (hydrogen) and CNG (compressed natural gas).

In this example, the impact detection system 502 is positioned to be in contact with at least a portion of the outer surface of the tank 500. Since in this example the tank is a CPOV tank, the impact detection system 502 is placed directly in contact with the overwrapped composite laminate 507.

In this example, the impact detection system 502 includes one or more flexible hollow tubes 510, embedded within a flexible layer 512 that is adapted to conform to the outer surface of the tank 500. The hollow tubes 510 may be made of flexible silicone, and filled with air or another gas. Furthermore, the flexible layer 512 may be made of a foam material (e.g., polystyrene foam) that can be shaped to conform the impact detection system 502 to the outer surface of the tank 500. The flexible layer 512 may be attached to the tank 500 using fasteners, adhesives, or other mechanisms, or may be shaped precisely to the surface of the tank 500 so as to not require any affixion mechanism.

The impact detection system 502 may be primarily placed alongside the underside of the tank 500, which is the region that is most susceptible to impacts. However, the positioning of the impact detection system 502 is not limited to the underside, and may also be placed anywhere along the outside of the tank 500 where impacts could potentially occur, including but not limited to the sides of the tank 500 for side impact detection.

The impact detection system 502 also includes at least one pressure sensor 515 positioned to detect a change in pressure within the hollow tubes 510 during an impact upon the tank 500 in the vicinity of the impact detection system 502. For the sake of clarity, only a single pressure sensor 515 is shown in FIG. 5, and the description below also applies to other pressure sensors of the impact detection system 502. Each of the hollow tubes 510 is associated with at least one such pressure sensor 515. Such an impact event would compress at least a portion of the hollow tubes 510 proximate to the point of impact, causing a decrease in volume of the air inside the proximal hollow tubes 510, and thereby increasing the pressure inside. The force of an impact event may also be distributed throughout the flexible layer 512, causing a change in pressure within some of the hollow tubes 510 that may not be proximate to the point of impact. The increase in pressure within an affected hollow tube 510 is then detected by a corresponding pressure sensor 515.

The pressure sensor 515 is in communicative contact with a processor 520. The pressure sensor 515 sends a signal to the processor 520 during detection of a change (e.g., a transient spike or a constant change) in pressure in the hollow tubes 510. The processor 520 processes the signal and determines whether the change in pressure was due to an impact event. For example, an impact event may be detected if the change in pressure in the hollow tubes 510 has a specific temporal profile (as measured in units of time), exceeds a pre-determined, calibrated threshold (as measured in units of pressure), or both (as measured in units of pressure, time, or pressure over time). Different thresholds may be used for a first indication of the severity of the impact.

Upon detection of an impact event, the processor 520 may provide one or more notifications, such as a notification that the tank 500 has been hit, or a notification that further inspection of the tank 500 is needed. The notifications may be provided to any appropriate personnel, including but not limited to the operator of the vehicle on which the tank 500 is mounted, or a service technician who will inspect the tank 500.

The impact detection system 502 may also include additional sensors, such as accelerometer 530 mounted to the tank 500 and in communicative contact with the processor 520. By combining signals from the accelerometer 530 in addition to signals from the pressure sensor 515, the processor 520 may estimate the severity of the impact event based on the change in pressure as well as the transient acceleration of the tank 500 due to the impact event.

In FIG. 5, the hollow tubes 510 are arranged within the flexible layer 512 in an axial pattern, parallel to the long axis of the tank 500. Alternatively, the hollow tubes 510 may be arranged within the flexible layer 512 in a radial pattern (not shown in FIG. 5), perpendicular to the long axis of the tank 400. The radial pattern may extend wholly or partially around the circumference of the tank 500.

The arrangement of the hollow tubes 510 is not limited to these configurations, but may instead be arranged in any pattern and orientation that provides sufficient spacing between the hollow tubes 510, to ensure that at least one of the hollow tubes 510 is impinged during any impact on the tank 500. The pattern may be dependent on the size and length of the tank 500, as well as the placement of the tank 500 on a vehicle and the expected area of concern where impacts may occur.

The hollow tubes 510 may be more widely spaced apart within the flexible layer 512 than if the hollow tubes 510 were not embedded in the flexible layer 512, since the flexible layer 512 may act to distribute the force of an impact event to more of the hollow tubes 510 than just those in the vicinity of the impact. In this manner, the flexible layer 512 may increase the sensitivity of the impact detection system 502 relative to impact detection systems without a flexible layer 512 (e.g., such as impact detection system 402 described above with respect to FIG. 4A and FIG. 4B). The use of the flexible layer 512 may therefore permit using fewer hollow tubes 510, hollow tubes 510 with shorter lengths and less material, or a combination of both. Using shorter tubes may also improve the sensitivity of impact detection since the total volume of air/liquid within the tube is less. As such, the potential impact would displace larger portion of the substance within the tube compared to the total amount of substance within tube.

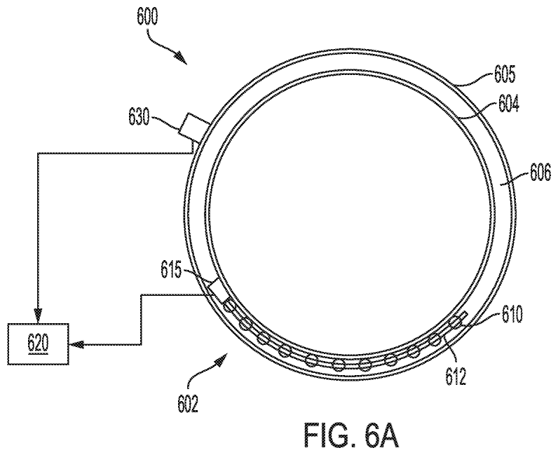

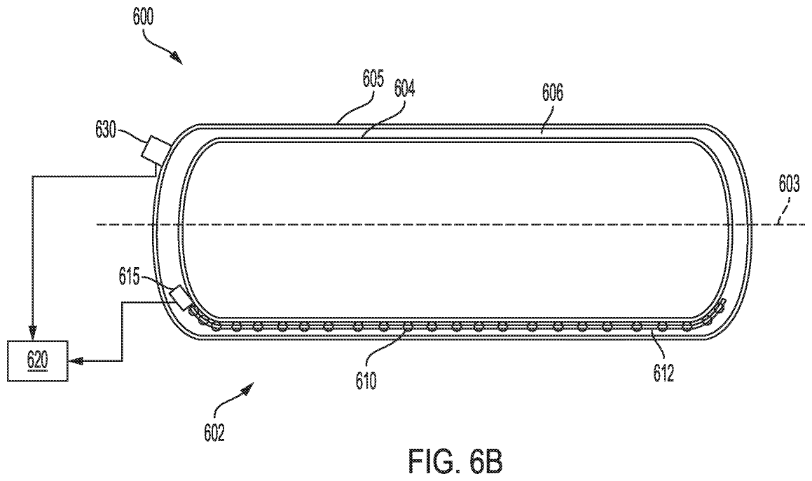

FIG. 6A and FIG. 6B show schematic views of an exemplary double-walled tank 600 equipped with an impact detection system 602, according to some examples of the present disclosure. The schematic view of the tank 600 in FIG. 6A is an axial view from the front of the tank 600 along the long axis of the tank 600 (not shown in FIG. 6A). The schematic view of the tank 600 in FIG. 6B is a radial view from the side of the tank perpendicular to the long axis 603 (indicated in FIG. 6B by a dashed line). The tank 600 is similar to previous examples, including but not limited to the example of the tank 300 discussed above with respect to FIG. 3, and like reference numerals have been used wherever possible to refer to the same or similar components. Any of the various features discussed with any one of the examples discussed herein may also apply to and be used with any other examples.

In this example, the tank 600 may be used to store cryogenically liquified gases including but not limited to LNG (liquified natural gas) and LH2 (liquified hydrogen). Since LNG is stored at typically −150 °C and LH2 at temperatures as low as −250 °C, proper insulation is achieved by the use of double tanks. The tank 600 includes an inner tank 604 that holds the liquid/gas combination at a low temperature, and outer tank 605 (also referred to as a shroud), and a gap 606 between the inner tank 604 and the outer tank 605. The gap 606 may be filled with insulating materials (not shown) or may be evacuated. Additional components of the tank, such as the cryogenic and safety subsystems (e.g., one or more components analogous to components 320-385 of the tank 300 described above with reference to FIG. 3) are omitted for the sake of clarity.

In the examples of FIG. 6A and FIG. 6B, the impact detection system 602 is positioned within the gap 606, and in contact with at least a portion of the outer surface of the inner tank 604. The impact detection system 602 may also be in contact with at least a portion of the inner surface of the outer tank 605 (i.e., sandwiched in between the inner tank 604 and the outer tank 605, or only in contact with the inner surface of the outer tank 605.

In this example, the impact detection system 602 includes one or more flexible hollow tubes 610, embedded within a flexible layer 612 that is adapted to conform to the outer surface of the inner tank 604.

Due to the very low temperature of the liquified fuel, the hollow tubes 610 may be made of a low-temperature compatible material, that can withstand cryogenic temperatures. The gas inside of the hollow tubes 610 may be a different gas than air to ensure the stability of the system at low temperatures.

Furthermore, the flexible layer 612 may be made of a foam material (e.g., polystyrene foam) that can be shaped to conform the impact detection system 602 to the outer surface of the inner tank 604. The flexible layer 612 may be attached to the tank 600 using fasteners, adhesives, or other mechanisms, or may be shaped precisely to the surface of the tank 600 so as to not require any affixion mechanism.

The hollow tubes 610 are primarily placed inside the gap 606 alongside the underside of the tank 600, which is the region that is most susceptible to impacts. However, the positioning of the impact detection system 602 is not limited to the underside, and may also be placed anywhere along the outside of the inner tank 604 where impacts could potentially occur, including but not limited to the sides of the tank 600 for side impact detection.

The impact detection system 602 also includes at least one pressure sensor 615 positioned to detect a change in pressure within the hollow tubes 610 during an impact upon the tank 600 in the vicinity of the impact detection system 602. Each of the hollow tubes 610 is associated with at least one such pressure sensor 615. For the sake of clarity, only a single pressure sensor 615 is shown in FIG. 6A and FIG. 6B, and the description below also applies to other pressure sensors of the impact detection system 602. Such an impact event would compress at least a portion of the hollow tubes 610 proximate to the point of impact, causing a decrease in volume of the air inside the proximal hollow tubes 610, and thereby increasing the pressure inside. The force of an impact event may also be distributed throughout the flexible layer 612, causing a change in pressure within some of the hollow tubes 610 that may not be proximate to the point of impact. The increase in pressure within an affected hollow tube 610 is then detected by a corresponding pressure sensor 615.

The pressure sensor 615 is in communicative contact with a processor 620. The pressure sensor 615 sends a signal to the processor 620 during detection of a change (e.g., a transient spike or a constant change) in pressure in the hollow tubes 610. The processor 620 processes the signal, and determines whether the change in pressure was due to an impact event. For example, an impact event may be detected if the change in pressure in the hollow tubes 610 has a specific temporal profile (as measured in units of time), exceeds a pre-determined and calibrated threshold (as measured in units of pressure), or both (as measured in units of pressure, time, or pressure over time). Different thresholds may be used for a first indication of the severity of the impact.

Upon detection of an impact event, the processor 620 may provide one or more notifications, such as a notification that the tank 600 has been hit, or a notification that further inspection of the tank 600 is needed. The notifications may be provided to any appropriate personnel, including but not limited to the operator of the vehicle on which the tank 600 is mounted, or a service technician who will inspect the tank 600.

The impact detection system 602 may also include additional sensors, such as accelerometer 630 mounted to the tank 600 and in communicative contact with the processor 620. The accelerometer is here shown mounted to the outer surface of the outer tank 605, but could alternatively be positioned within the gap 606 on either the inner surface of the outer tank 605, or the outer surface of the inner tank 604. By combining signals from the accelerometer 630 in addition to signals from the pressure sensor 615, the processor 620 may estimate the severity of the impact event based on the change in pressure as well as the transient acceleration of the tank 600 due to the impact event.

In FIG. 6A, the hollow tubes 610 are arranged within the flexible layer 612 in an axial pattern, parallel to the long axis of the tank 600. Alternatively, as shown in FIG. 6B, the hollow tubes 610 may be arranged in a radial pattern, perpendicular to the long axis of the tank 600. The radial pattern may extend wholly or partially around the circumference of the tank 600.

The arrangement of the hollow tubes 610 is not limited to these configurations, but may instead be arranged in any pattern and orientation that provides sufficient spacing between the hollow tubes 610, to ensure that at least one of the hollow tubes 610 is impinged during any impact on the tank 600. The pattern may be dependent on the size and length of the tank 600, as well as the placement of the tank 600 on a vehicle and the expected area of concern where impacts may occur.

The hollow tubes 610 may be more widely spaced apart within the flexible layer 612 than if the hollow tubes 610 were not embedded in the flexible layer 612, since the flexible layer 612 may act to distribute the force of an impact event to more of the hollow tubes 610 than just those in the vicinity of the impact. In this manner, the flexible layer 612 may increase the sensitivity of the impact detection system 602 relative to impact detection systems without a flexible layer 612. In addition, the flexible layer may at least partially be in contact with the inner surface of the outer tank 605, providing additional sensitivity to impact events. The use of the flexible layer 612 may therefore permit using fewer hollow tubes 610, hollow tubes 610 with shorter lengths and less material, or a combination of both.

In some cases, impact detection systems (e.g., impact detection system 402, impact detection system 502, impact detection system 602, etc.) have multiple hollow tubes to cover a vulnerable region of the tank (e.g., the underside), placed in a pattern (including but not limited to an axial pattern or a radial pattern) with a sufficiently dense spacing between each tube such that an impact event on the vulnerable region impacts at least one of the hollow tubes. Such multi-tube systems involve the use of multiple pressure sensors, such that the resulting change in pressure in any one tube is detected by at least one pressure sensor during an impact event.

In other cases, impact detection systems may have a single, winding hollow tube to cover a vulnerable region of the tank. The single hollow tube may have a winding pattern with a sufficiently dense spacing between each tube such that an impact event on the vulnerable region impacts at least one of the hollow tubes. The winding pattern may be parallel to one of the axes of the tank, or at an angle. Such single-tube systems involve the use of one or two pressure sensors to detect the resulting change in pressure in the tube during an impact event. The length of the single hollow tube may depend upon the spacing of the windings and the desired area of coverage on the surface of the tank.

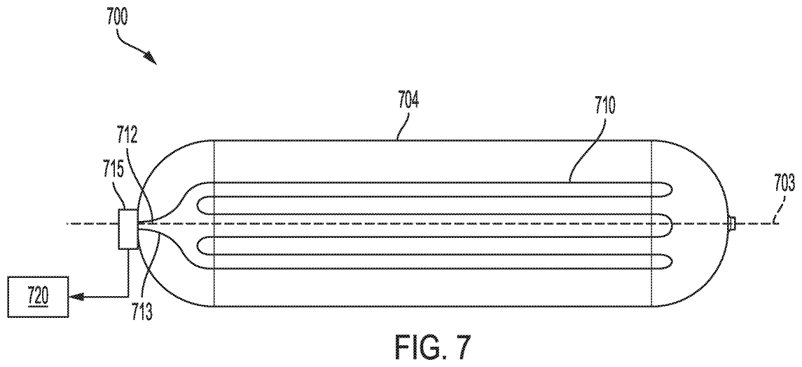

FIG. 7 shows a schematic view of an exemplary tank 700 equipped with a single-tube impact detection system 702, according to some examples of the present disclosure. The schematic view of the tank 700 in FIG. 7 is a radial view from the side of the tank perpendicular to the long axis 703 (indicated by a dashed line). In this example, the tank 700 includes a tank wall 704, that may be an inner tank of a double-walled tank used to store cryogenically liquified gases, or may be a single-walled composite overwrapped pressure vessel (CPOV) used to store gaseous fuels.

The tank 700 is similar to previous examples, including but not limited to the examples of the tank 400 and the tank 600, discussed above with respect to FIG. 4B and FIG. 6B respectively, and like reference numerals have been used wherever possible to refer to the same or similar components. Any of the various features discussed with any one of the examples discussed herein may also apply to and be used with any other examples.

In the example of FIG. 7, the impact detection system 702 includes a single flexible hollow tube 710 that is adapted to conform to the outer surface of the tank wall 704. the hollow tube 710 may be made of silicone, or a low-temperature compatible material. The gas inside of the hollow tube 710 may be air, or may be a different gas to ensure the stability of the system at low temperatures. The hollow tube 710 may be embedded within a flexible layer (not shown), which may be made of a foam material (e.g., polystyrene foam) that can be shaped to conform the impact detection system 702 to the outer surface of the tank wall 704. The impact detection system 702 may be attached to the tank wall 704 using fasteners, adhesives, or other mechanisms, or may be shaped precisely to the surface of the tank wall 704 so as to not require any affixion mechanism.

The hollow tube 710 is arranged in an axial winding pattern, which runs back and forth along the long axis 703, along the underside of the tank wall 704. In this arrangement, a first end 712 of the hollow tube 710 and a second end 713 of the hollow tube 710 are both adjacent, being located at one point on surface of the tank 700. The impact detection system 702 also includes a single pressure sensor 715 positioned proximate to both the first end 712 and the second end 713 of the hollow tube 710. In this location, the pressure sensor 715 is positioned to detect a change in pressure within the hollow tube 710 during an impact upon the tank 700 in the vicinity of the impact detection system 702. Such an impact event would compress at least a portion of the hollow tube 710 that is proximate to the point of impact, causing a decrease in volume of the air inside the hollow tube 710, and thereby increasing the pressure inside.

The pressure sensor 715 is in communicative contact with a processor 720. The pressure sensor 715 sends a signal to the processor 720 during detection of a change (e.g., a transient spike or a constant change) in pressure in the hollow tube 710. The processor 720 processes the signal and determines whether the change in pressure was due to an impact event. For example, an impact event may be detected if the change in pressure in the hollow tubes 710 has a specific temporal profile (as measured in units of time), exceeds a pre-determined and calibrated threshold (as measured in units of pressure), or both (as measured in units of pressure, time, or pressure over time). Different thresholds may be used for a first indication of the severity of the impact.

After an impact event, a pressure wave is generated within the hollow tube 710 that travels in both directions along the hollow tube 710, away from the point of impact. Since the pressure sensor 715 is positioned proximate to both ends 712, 713 of the hollow tube 710, the pressure sensor 715 may detect the pressure wave at two different times, and therefore send two different signals to the processor 720 at different times. In some cases, the processor 720 may determine the location along the hollow tube 710 nearest to the impact point upon the tank wall 704, by performing a calculation that depends upon the difference in the time the two signals were received from the pressure sensor 715. This calculation is at least dependent on the known length of the hollow tube 710. If the spacing of the axial winding pattern is dense enough, then the impact event may impinge upon the hollow tube 710 at more than one location, generating additional pressure waves that are detected by the pressure sensor 715, which sends additional signals to the processor 720 to further refine the determination of the point of impact.

Upon detection of an impact event, the processor 720 may provide one or more notifications, such as a notification that the tank 700 has been hit, or a notification that further inspection of the tank 700 is needed. The notifications may be provided to any appropriate personnel, including but not limited to the operator of the vehicle on which the tank 700 is mounted, or a service technician who will inspect the tank 700. The approximate location of the impact could be made available for driver and/or mechanic to reduce the inspection time and increase inspection quality.

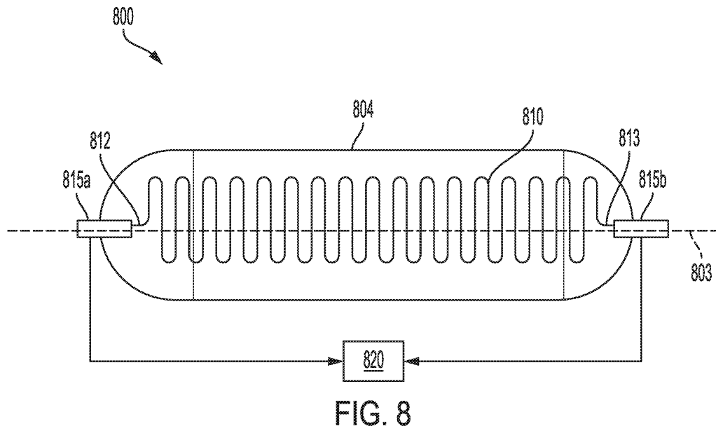

FIG. 8 shows a schematic view of an exemplary tank 800 equipped with a single-tube impact detection system 802, according to some examples of the present disclosure. The schematic view of the tank 800 in FIG. 8 is a radial view from the side of the tank perpendicular to the long axis 803 (indicated by a dashed line). In this example, the tank 800 includes a tank wall 804, that may be an inner tank of a double-walled tank used to store cryogenically liquified gases, or may be a single-walled composite overwrapped pressure vessel (CPOV) used to store gaseous fuels.

The tank 800 is similar to previous examples, including but not limited to the example of the tank 700, discussed above with respect to FIG. 7, and like reference numerals have been used wherever possible to refer to the same or similar components. Any of the various features discussed with any one of the examples discussed herein may also apply to and be used with any other examples.

In the example of FIG. 8, the impact detection system 802 includes a single flexible hollow tube 810 that is adapted to conform to the outer surface of the tank wall 804. the hollow tube 810 may be made of silicone, or a low-temperature compatible material. The gas inside of the hollow tube 810 may be air, or may be a different gas to ensure the stability of the system at low temperatures. The hollow tube 810 may be embedded within a flexible layer (not shown), which may be made of a foam material (e.g., polystyrene foam) that can be shaped to conform the impact detection system 802 to the outer surface of the tank wall 804. The impact detection system 802 may be attached to the tank wall 804 using fasteners, adhesives, or other mechanisms, or may be shaped precisely to the surface of the tank wall 804 so as to not require any affixion mechanism.

The hollow tube 810 is arranged in a radial winding pattern, which runs back and forth perpendicular to the long axis 803, along the underside of the tank wall 804. In this arrangement, a first end 812 of the hollow tube 810 is located at one point on surface of the tank 800, and a second end 813 of the hollow tube 810 is located at another point on the surface of the tank 800. The impact detection system 802 also includes a first pressure sensor 815a positioned proximate to the first end 812 of the hollow tube 810, and a second pressure sensor 815b positioned proximate to the second end 813 of the hollow tube 810. In these locations, the pressure sensors 815a, 815b are positioned to detect a change in pressure within the hollow tube 810 during an impact upon the tank 800 in the vicinity of the impact detection system 802. Such an impact event would compress at least a portion of the hollow tube 810 that is proximate to the point of impact, causing a decrease in volume of the air inside the hollow tube 810, and thereby increasing the pressure inside.

The pressure sensor 815 is in communicative contact with a processor 820. The pressure sensor 815 sends a signal to the processor 820 during detection of a change (e.g., a transient spike or a constant change) in pressure in the hollow tube 810. The processor 820 processes the signal and determines whether the change in pressure was due to an impact event. For example, an impact event may be detected if the change in pressure in the hollow tubes 810 has a specific temporal profile (as measured in units of time), exceeds a pre-determined and calibrated threshold (as measured in units of pressure), or both (as measured in units of pressure, time, or pressure over time). Different thresholds may be used for a first indication of the severity of the impact.

After an impact event, a pressure wave is generated within the hollow tube 810 that travels in both directions along the hollow tube 810, away from the point of impact. Since the pressure sensors 815a, 815b are positioned proximate to opposite ends 812, 813 of the hollow tube 810, the pressure sensors 815a, 815b may detect the pressure wave at two different times, and therefore send signals to the processor 820 at different times. In some cases, the processor 820 may determine the location along the hollow tube 810 nearest to the impact point upon the tank wall 804, by performing a calculation that depends upon the difference in the time the two signals were received from the pressure sensors 815a, 815b. This calculation is at least dependent on the known length of the hollow tube 810. If the spacing of the radial winding pattern is dense enough, then the impact event may impinge upon the hollow tube 810 at more than one location, generating additional pressure waves that are detected by the pressure sensors 815a, 815b, which send additional signals to the processor 820 to further refine the determination of the point of impact.

Upon detection of an impact event, the processor 820 may provide one or more notifications, such as a notification that the tank 800 has been hit, a notification that further inspection of the tank 800 is needed, or a notification of the location of the impact upon the tank 800. The notifications may be provided to any appropriate personnel, including but not limited to the operator of the vehicle on which the tank 800 is mounted, or a service technician who will inspect the tank 800.

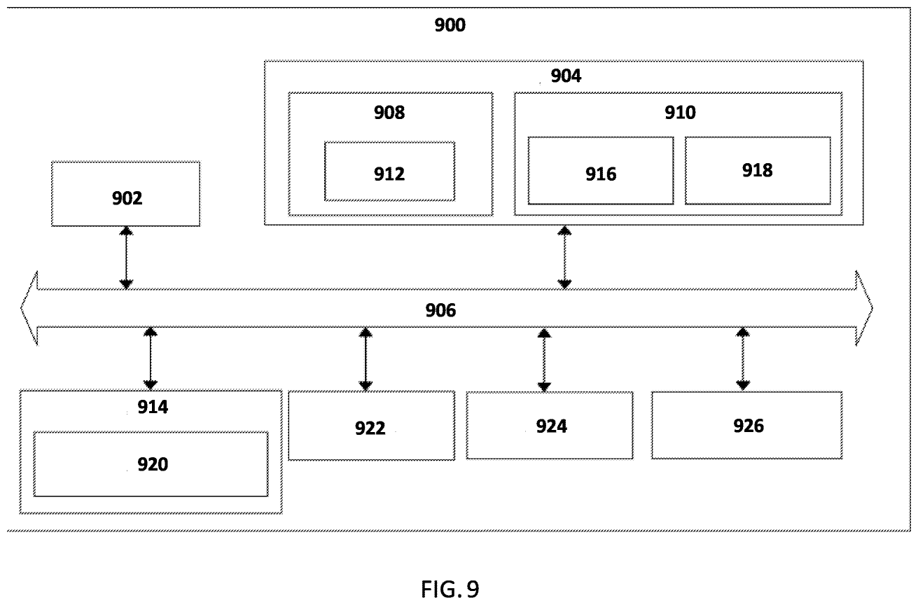

FIG. 9 is a schematic diagram of a computer system 900 for implementing examples disclosed herein. The computer system 900 is adapted to execute instructions from a computer-readable medium to perform these and/or any of the functions or processing described herein. The computer system 900 may be connected (e.g., networked) to other machines in a LAN, an intranet, an extranet, or the Internet. While only a single device is illustrated, the computer system 900 may include any collection of devices that individually or jointly execute a set (or multiple sets) of instructions to perform any one or more of the methodologies discussed herein. Accordingly, any reference in the disclosure and/or claims to a computer system, computing system, computer device, computing device, control system, control unit, electronic control unit (ECU), processor device, processing circuitry, etc., includes reference to one or more such devices to individually or jointly execute a set (or multiple sets) of instructions to perform any one or more of the methodologies discussed herein. For example, control system may include a single control unit or a plurality of control units connected or otherwise communicatively coupled to each other, such that any performed function may be distributed between the control units as desired. Further, such devices may communicate with each other or other devices by various system architectures, such as directly or via a Controller Area Network (CAN) bus, etc.

The computer system 900 may comprise at least one computing device or electronic device capable of including firmware, hardware, and/or executing software instructions to implement the functionality described herein. The computer system 900 may include processing circuitry 902 (e.g., processing circuitry including one or more processor devices or control units), a memory 904, and a system bus 906. The computer system 900 may include at least one computing device having the processing circuitry 902. The system bus 906 provides an interface for system components including, but not limited to, the memory 904 and the processing circuitry 902. The processing circuitry 902 may include any number of hardware components for conducting data or signal processing or for executing computer code stored in memory 904. The processing circuitry 902 may, for example, include a general-purpose processor, an application specific processor, a Digital Signal Processor (DSP), an Application Specific Integrated Circuit (ASIC), a Field Programmable Gate Array (FPGA), a circuit containing processing components, a group of distributed processing components, a group of distributed computers configured for processing, or other programmable logic device, discrete gate or transistor logic, discrete hardware components, or any combination thereof designed to perform the functions described herein. The processing circuitry 902 may further include computer executable code that controls operation of the programmable device.

The system bus 906 may be any of several types of bus structures that may further interconnect to a memory bus (with or without a memory controller), a peripheral bus, and/or a local bus using any of a variety of bus architectures. The memory 904 may be one or more devices for storing data and/or computer code for completing or facilitating methods described herein. The memory 904 may include database components, object code components, script components, or other types of information structure for supporting the various activities herein. Any distributed or local memory device may be utilized with the systems and methods of this description. The memory 904 may be communicably connected to the processing circuitry 902 (e.g., via a circuit or any other wired, wireless, or network connection) and may include computer code for executing one or more processes described herein. The memory 904 may include non-volatile memory 908 (e.g., read-only memory (ROM), erasable programmable read-only memory (EPROM), electrically erasable programmable read-only memory (EEPROM), etc.), and volatile memory 910 (e.g., random-access memory (RAM)), or any other medium which can be used to carry or store desired program code in the form of machine-executable instructions or data structures and which can be accessed by a computer or other machine with processing circuitry 902. A basic input/output system (BIOS) 912 may be stored in the non-volatile memory 908 and can include the basic routines that help to transfer information between elements within the computer system 900.

The computer system 900 may further include or be coupled to a non-transitory computer-readable storage medium such as the storage device 914, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 914 and other drives associated with computer-readable media and computer-usable media may provide non-volatile storage of data, data structures, computer-executable instructions, and the like.

Computer-code which is hard or soft coded may be provided in the form of one or more modules. The module(s) can be implemented as software and/or hard-coded in circuitry to implement the functionality described herein in whole or in part. The modules may be stored in the storage device 914 and/or in the volatile memory 910, which may include an operating system 916 and/or one or more program modules 918. All or a portion of the examples disclosed herein may be implemented as a computer program 920 stored on a transitory or non-transitory computer-usable or computer-readable storage medium (e.g., single medium or multiple media), such as the storage device 914, which includes complex programming instructions (e.g., complex computer-readable program code) to cause the processing circuitry 902 to carry out actions described herein. Thus, the computer-readable program code of the computer program 920 can comprise software instructions for implementing the functionality of the examples described herein when executed by the processing circuitry 902. In some examples, the storage device 914 may be a computer program product (e.g., readable storage medium) storing the computer program 920 thereon, where at least a portion of a computer program 920 may be loadable (e.g., into a processor) for implementing the functionality of the examples described herein when executed by the processing circuitry 902. The processing circuitry 902 may serve as a controller or control system for the computer system 900 that is to implement the functionality described herein.

The computer system 900 may include an input device interface 922 configured to receive input and selections to be communicated to the computer system 900 when executing instructions, such as from a keyboard, mouse, touch-sensitive surface, etc. Such input devices may be connected to the processing circuitry 902 through the input device interface 922 coupled to the system bus 906 but can be connected through other interfaces, such as a parallel port, an Institute of Electrical and Electronic Engineers (IEEE) 1394 serial port, a Universal Serial Bus (USB) port, an IR interface, and the like. The computer system 900 may include an output device interface 924 configured to forward output, such as to a display, a video display unit (e.g., a liquid crystal display (LCD) or a cathode ray tube (CRT)). The computer system 900 may include a communications interface 926 suitable for communicating with a network as appropriate or desired.

The operational actions described in any of the exemplary aspects herein are described to provide examples and discussion. The actions may be performed by hardware components, may be embodied in machine-executable instructions to cause a processor to perform the actions, or may be performed by a combination of hardware and software. Although a specific order of method actions may be shown or described, the order of the actions may differ. In addition, two or more actions may be performed concurrently or with partial concurrence.

Example 1: A system for impact detection, comprising a pressure vessel configured to store a fuel, said pressure vessel comprising a wall having an outer surface and an inner surface defining a cavity therein for storing said fuel; and a pressure sensor assembly positioned to be in contact with a portion of said outer surface of said wall, said pressure sensor assembly comprising: a flexible layer adapted to conform to said portion of said outer surface of said wall; a tube within said flexible layer; a pressure sensor positioned to detect a change in pressure within said tube during an impact upon said flexible layer; and a processor in communication with said pressure sensor, said processor configured to detect the impact based on the change in pressure.

Example 2: The system of example 1, wherein said tube is arranged in an alternating pattern extending back and forth along an axis of the pressure vessel.

Example 3: The system of example 2, wherein said tube has a first end and a second end that are adjacent due to said alternating pattern, and said pressure sensor is arranged proximate to both the first end and the second end of said tube.

Example 4: The system of any of examples 1-3, wherein said pressure sensor assembly further comprises a plurality of tubes arranged in parallel within said flexible layer, and a plurality of pressure sensors each being in communication with said processor and each being positioned to detect a change in pressure within at least one of said plurality of tubes during said impact.

Example 5: The system of any of examples 1-4, wherein said tube is a first tube and said pressure sensor is a first pressure sensor, and wherein said pressure sensor assembly further comprises a second tube embedded within said flexible layer and a second pressure sensor, said second pressure sensor being in communication with said processor and being positioned to detect a change in pressure within said second tube during said impact.

Example 6: The system of any of examples 1-5, wherein said pressure sensor is a first pressure sensor, said first pressure sensor being further positioned at a first end of the tube, and wherein said pressure sensor assembly further comprises a second pressure sensor, said second pressure sensor being in communication with said processor and being positioned at a second end of the tube to detect a change in pressure within said tube during said impact.

Example 7: The system of any of examples 1-6, wherein said outer surface of said pressure vessel comprises an overwrapped layer of composite material, and said flexible layer is positioned to be in contact with said overwrapped layer of composite material.

Example 8: The system of any of examples 1-7, wherein at least a portion of said tube is in direct contact with said outer surface of said wall.

Example 9: The system of any of examples 1-8, wherein said tube is fully embedded within said flexible layer.

Example 10: The system of any of examples 1-9, wherein said flexible layer is composed of a material that propagates a force from said impact to said tube.

Example 11: The system of any of examples 1-10, wherein said processor is further configured to determine at least one of a position of said impact and a severity of said impact.

Example 12: A vehicle, comprising:
a frame; and
a pressure vessel mounted to said frame, said pressure vessel being configured to store a fuel and comprising a wall having an outer surface and an inner surface defining a cavity therein for storing said fuel; and
a pressure sensor assembly positioned to be in contact with a portion of said outer surface of said wall, said pressure sensor assembly comprising:
   a flexible layer adapted to conform to said portion of said outer surface of said wall;
   a tube within said flexible layer;
   a pressure sensor positioned to detect a change in pressure within said tube during an impact upon said flexible layer; and
   a processor in communication with said pressure sensor, said processor configured to detect the impact based on the change in pressure.

Example 13: The vehicle of example 12, wherein said tube is arranged in an alternating pattern extending back and forth along an axis of the pressure vessel.

Example 14: The vehicle of any of examples 12-13, wherein said tube has a first end and a second end that are adjacent due to said alternating pattern, and said pressure sensor is arranged proximate to both the first end and the second end of said tube.

Example 15: The vehicle of any of examples 12-14, wherein said pressure sensor assembly further comprises a plurality of tubes arranged in parallel within said flexible layer, and a plurality of pressure sensors each being in communication with said processor and each being positioned to detect a change in pressure within at least one of said plurality of tubes during said impact.

Example 16: The vehicle of any of examples 12-15, wherein said pressure sensor is a first pressure sensor, said first pressure sensor being further positioned at a first end of the tube, and
wherein said pressure sensor assembly further comprises a second pressure sensor, said second pressure sensor being in communication with said processor and being positioned at a second end of the tube to detect a change in pressure within said tube during said impact.

Example 17: The vehicle of any of examples 12-16, wherein said outer surface of said pressure vessel comprises an overwrapped layer of composite material, and said flexible layer is positioned to be in contact with said overwrapped layer of composite material.

Example 18: A sensor assembly for impact detection, comprising:
a flexible layer;
a tube within said flexible layer;
a pressure sensor positioned to detect a change in pressure within said tube during an impact upon said flexible layer; and
a processor in communication with said pressure sensor, said processor configured to detect the impact based on the change in pressure,
wherein said sensor assembly is positioned to be in contact with a portion of an outer surface of a wall of a pressure vessel configured to store a fuel.

Example 19: The sensor assembly of example 18, wherein said tube is arranged in an alternating pattern extending back and forth along an axis of the pressure vessel, and
wherein said tube has a first end and a second end that are adjacent due to said alternating pattern, and said pressure sensor is arranged proximate to both the first end and the second end of said tube.

Example 20: The sensor assembly of any of examples 18-19, wherein said sensor assembly further comprises a plurality of tubes arranged in parallel within said flexible layer, and a plurality of pressure sensors each being in communication with said processor and each being positioned to detect a change in pressure within at least one of said plurality of tubes during said impact.

Example 21: The sensor assembly of any of examples 18-20, wherein said pressure sensor is a first pressure sensor, said first pressure sensor being further positioned at a first end of the tube, and
wherein said sensor assembly further comprises a second pressure sensor, said second pressure sensor being in communication with said processor and being positioned at a second end of the tube to detect a change in pressure within said tube during said impact.

Example 22: The sensor assembly of any of examples 18-21, wherein said outer surface comprises an overwrapped layer of composite material, and said flexible layer is positioned to be in contact with said overwrapped layer of composite material.

The terminology used herein is for the purpose of describing particular aspects only and is not intended to be limiting of the disclosure. As used herein, the singular forms “a,” “an,” and “the” are intended to include the plural forms as well, unless the context clearly indicates otherwise. As used herein, the term “and/or” includes any and all combinations of one or more of the associated listed items. It will be further understood that the terms “comprises,” “comprising,” “includes,” and/or “including” when used herein specify the presence of stated features, integers, actions, steps, operations, elements, and/or components, but do not preclude the presence or addition of one or more other features, integers, actions, steps, operations, elements, components, and/or groups thereof.

It will be understood that, although the terms first, second, etc., may be used herein to describe various elements, these elements should not be limited by these terms. These terms are only used to distinguish one element from another. For example, a first element could be termed a second element, and, similarly, a second element could be termed a first element without departing from the scope of the present disclosure.

Relative terms such as “below” or “above” or “upper” or “lower” or “horizontal” or “vertical” may be used herein to describe a relationship of one element to another element as illustrated in the Figures. It will be understood that these terms and those discussed above are intended to encompass different orientations of the device in addition to the orientation depicted in the Figures. It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present.

Unless otherwise defined, all terms (including technical and scientific terms) used herein have the same meaning as commonly understood by one of ordinary skill in the art to which this disclosure belongs. It will be further understood that terms used herein should be interpreted as having a meaning consistent with their meaning in the context of this specification and the relevant art and will not be interpreted in an idealized or overly formal sense unless expressly so defined herein.

It is to be understood that the present disclosure is not limited to the aspects described above and illustrated in the drawings; rather, the skilled person will recognize that many changes and modifications may be made within the scope of the present disclosure and appended claims. In the drawings and specification, there have been disclosed aspects for purposes of illustration only and not for purposes of limitation, the scope of the disclosure being set forth in the following claims.

1. A system for impact detection, comprising:
a pressure vessel configured to store a fuel, said pressure vessel comprising a wall having an outer surface and an inner surface defining a cavity therein for storing said fuel; and
a pressure sensor assembly positioned to be in contact with a portion of said outer surface of said wall, said pressure sensor assembly comprising:
a flexible layer adapted to conform to said portion of said outer surface of said wall;
a tube within said flexible layer;
a pressure sensor positioned to detect a change in pressure within said tube during an impact upon said flexible layer; and
a processor in communication with said pressure sensor, said processor configured to detect the impact based on the change in pressure.

2. The system of claim 1, wherein said tube is arranged in an alternating pattern extending back and forth along an axis of the pressure vessel.

3. The system of claim 2, wherein said tube has a first end and a second end that are adjacent due to said alternating pattern, and said pressure sensor is arranged proximate to both the first end and the second end of said tube.

4. The system of claim 1, wherein said pressure sensor assembly further comprises a plurality of tubes arranged in parallel within said flexible layer, and a plurality of pressure sensors each being in communication with said processor and each being positioned to detect a change in pressure within at least one of said plurality of tubes during said impact.

5. The system of claim 1, wherein said tube is a first tube and said pressure sensor is a first pressure sensor, and
wherein said pressure sensor assembly further comprises a second tube embedded within said flexible layer and a second pressure sensor, said second pressure sensor being in communication with said processor and being positioned to detect a change in pressure within said second tube during said impact.

6. The system of claim 1, wherein said pressure sensor is a first pressure sensor, said first pressure sensor being further positioned at a first end of the tube, and
wherein said pressure sensor assembly further comprises a second pressure sensor, said second pressure sensor being in communication with said processor and being positioned at a second end of the tube to detect a change in pressure within said tube during said impact.

7. The system of claim 1, wherein said outer surface of said pressure vessel comprises an overwrapped layer of composite material, and said flexible layer is positioned to be in contact with said overwrapped layer of composite material.

8. The system of claim 1, wherein at least a portion of said tube is in direct contact with said outer surface of said wall.

9. The system of claim 1, wherein said tube is fully embedded within said flexible layer.

10. The system of claim 1, wherein said flexible layer is composed of a material that propagates a force from said impact to said tube.

11. The system of claim 1, wherein said processor is further configured to determine at least one of a position of said impact and a severity of said impact.

12. A vehicle, comprising:
a frame; and
a pressure vessel mounted to said frame, said pressure vessel being configured to store a fuel and comprising a wall having an outer surface and an inner surface defining a cavity therein for storing said fuel; and
a pressure sensor assembly positioned to be in contact with a portion of said outer surface of said wall, said pressure sensor assembly comprising:
a flexible layer adapted to conform to said portion of said outer surface of said wall;
a tube within said flexible layer;
a pressure sensor positioned to detect a change in pressure within said tube during an impact upon said flexible layer; and
a processor in communication with said pressure sensor, said processor configured to detect the impact based on the change in pressure.

13. The vehicle of claim 12, wherein said tube is arranged in an alternating pattern extending back and forth along an axis of the pressure vessel.

14. The vehicle of claim 12, wherein said tube has a first end and a second end that are adjacent due to said alternating pattern, and said pressure sensor is arranged proximate to both the first end and the second end of said tube.

15. The vehicle of claim 12, wherein said pressure sensor assembly further comprises a plurality of tubes arranged in parallel within said flexible layer, and a plurality of pressure sensors each being in communication with said processor and each being positioned to detect a change in pressure within at least one of said plurality of tubes during said impact.

16. The vehicle of claim 12, wherein said pressure sensor is a first pressure sensor, said first pressure sensor being further positioned at a first end of the tube, and
wherein said pressure sensor assembly further comprises a second pressure sensor, said second pressure sensor being in communication with said processor and being positioned at a second end of the tube to detect a change in pressure within said tube during said impact.

17. The vehicle of claim 12, wherein said outer surface of said pressure vessel comprises an overwrapped layer of composite material, and said flexible layer is positioned to be in contact with said overwrapped layer of composite material.

18. A sensor assembly for impact detection, comprising:
a flexible layer;
a tube within said flexible layer;
a pressure sensor positioned to detect a change in pressure within said tube during an impact upon said flexible layer; and
a processor in communication with said pressure sensor, said processor configured to detect the impact based on the change in pressure,
wherein said sensor assembly is positioned to be in contact with a portion of an outer surface of a wall of a pressure vessel configured to store a fuel.

19. The sensor assembly of claim 18, wherein said tube is arranged in an alternating pattern extending back and forth along an axis of the pressure vessel, and
wherein said tube has a first end and a second end that are adjacent due to said alternating pattern, and said pressure sensor is arranged proximate to both the first end and the second end of said tube.

20. The sensor assembly of claim 18, wherein said sensor assembly further comprises a plurality of tubes arranged in parallel within said flexible layer, and a plurality of pressure sensors each being in communication with said processor and each being positioned to detect a change in pressure within at least one of said plurality of tubes during said impact.

21. The sensor assembly of claim 18, wherein said pressure sensor is a first pressure sensor, said first pressure sensor being further positioned at a first end of the tube, and
wherein said sensor assembly further comprises a second pressure sensor, said second pressure sensor being in communication with said processor and being positioned at a second end of the tube to detect a change in pressure within said tube during said impact.

22. The sensor assembly of claim 18, wherein said outer surface comprises an overwrapped layer of composite material, and said flexible layer is positioned to be in contact with said overwrapped layer of composite material.
